(19) United States
(12) Patent Application Publication
(10) Pub. No.: US 2011/0310625 A1
(43) Pub. Date: Dec. 22, 2011

(54) Light Fixtures Comprising Organic Light Emitting Diodes

(75) Inventors: John T. Mayfield, III, Loganville, GA (US); Jeffrey M. Quinlan, Covington, GA (US); Forrest S. McCanless, Oxford, GA (US)

(73) Assignee: ABL IP Holding LLC, Conyers, GA (US)

(21) Appl. No.: 12/816,558

(22) Filed: Jun. 16, 2010

(51) Int. Cl. F21V 15/01; B23P 6/00

(52) U.S. Cl. 362/375; 29/401.1

(57) ABSTRACT

Light fixtures comprising an organic light emitting diode (OLED) as the light source, and further comprising a housing, at least one hollow, and an optic. The at least one hollow defines an intended area where light is emitted, and includes a reflective surface to reflect light within the intended area. The optic comprises a refractive portion that is defined by two edges. In one embodiment, the OLED is coupled to the two edges of the optic. In another embodiment, the OLED is coupled to and contacts an inner surface of the refractive portion. In either embodiment, the OLED is either sufficiently close to or contacting the refractive portion such that surface area of emitted light is maximized. Additionally, the OLED is placed sufficiently close to (or within) the intended area that reflected light and optical efficiency are maximized.

### FIELD OF THE INVENTION

The invention relates generally to light fixtures, and in particular, to the use of organic light emitting diodes in light fixtures.

### BACKGROUND OF THE INVENTION

An important consideration in the design of light fixtures is selection of the light source. Fluorescent lamps have long been the light source of choice in many commercial applications, particularly for indoor office lighting. There are many types of fluorescent lamps, such as a linear T8 (1 inch diameter), T12 (1.5 inch diameter), or T5 (⅝inch diameter) lamps manufactured by Osram/Sylvania and others. These fluorescent lamps provide distribution efficiencies and high lumen output, favorable qualities when illuminating a space.

But fluorescent lamps have drawbacks as well. For example, fluorescent lamps have a high lumen output and are very compact—the popular T5 lamp only has a ⅝inch diameter—which results in a high luminous intensity per unit area. Bright and intense fluorescent lamps may be uncomfortable and may also result in undesirable direct lighting. “Direct lighting” means that the light is only directed into the space immediately below the light fixture, which leaves other areas of the space dark. For example, if a light fixture having a fluorescent lamp is mounted to a ceiling of a room, then the floor immediately below the light fixture might be very bright, but the upper portions of walls in the room may be dark. Direct light may create a defined line between the directly lit and dark areas, which creates the perception of a ceiling that is lower than it actually is. In general, direct lighting may impair the comfort of the illuminated space.

It may be desirable to reduce the amount of direct lighting and instead create volumetric lighting. The term “volumetric lighting” means lighting that is less directional and more uniform throughout the entire illuminated space. The space feels brighter, larger, more public, and more relaxing. Facial rendering is more natural, consistent, and complimentary. Shadows tend to be softer and less pronounced, and the appearance of the space is less defined by sharp, arbitrary transitions in surface brightness. Volumetric lighting does a better job of rendering architecture, its contents, and its occupants true to form.

The brightness of the fluorescent lamp can be reduced (and volumetric lighting may be created) if the surface area from which the light emanates is increased in size. Thus, systems are known that use optics to cover or substantially surround the fluorescent lamp. Optics generally have a larger surface area than fluorescent lamps, and refract the light over this larger surface area. Optics may include lenses, shields, or other covers with refractive surfaces. But optics may defeat the advantages of a fluorescent lamp; for example, optics may create distracting changes in brightness level and pattern as seen by a moving observer in the illuminated space.

Thus, there exists a need for light fixtures that minimize the amount of direct lighting and increase the amount of volumetric lighting without sacrificing the benefits of the light source.

### SUMMARY OF THE INVENTION

Certain embodiments of the invention provide a light fixture having an organic light emitting diode (OLED) as the light source. An OLED is a light-emitting diode (LED) whose emissive electroluminescent layer is composed of a film of organic compounds. An OLED typically has a first surface and a second surface opposite the first surface. The second surface emits light. OLEDs are particularly suitable for use in light fixtures because they may be printed on substrates having a large surface area, and light sources that have a larger surface areas are better at producing volumetric light than those with smaller surface areas.

Certain embodiments of this invention thus include an OLED as the light source, and further include a housing, at least one hollow, and an optic. The at least one hollow defines an intended area into which light is emitted, and includes a reflective surface to reflect light within the intended area. The optic comprises a refractive portion that is defined by two edges, and further, the refractive portion includes an inner surface and an outer surface that faces the intended area.

In one embodiment, the OLED is coupled to the two edges of the optic. Due to the geometry of the optic the OLED is very close to the refractive portion. In another embodiment, the second surface of the OLED is coupled to and contacts the inner surface of the refractive portion. In either embodiment, the OLED is either sufficiently close to or contacting the refractive portion such that surface area of emitted light is maximized. Thus, to an observer it appears as though the refractive portion itself is the light source. Additionally, the OLED is placed sufficiently close to (or within) the intended area that reflected light and optical efficiency are maximized.

Embodiments of the invention thus provide for improved lighting by providing OLEDs as a light source, and by placing those OLEDs within the light source in a manner that maximizes surface area of the emitted light and also maximizes the amount of reflected light.

### BRIEF DESCRIPTION OF THE DRAWINGS

A full and enabling disclosure including the best mode of practicing the appended claims and directed to one of ordinary skill in the art is set forth more particularly in the remainder of the specification. The specification makes reference to the following appended figures, in which use of like reference numerals in different features is intended to illustrate like or analogous components.

FIG. 1 is a bottom perspective view of a light fixture according to one embodiment of the invention.

FIG. 2 is a cross-sectional view of the light fixture of FIG. 1 taken along line 2-2.

FIG. 3 is a bottom perspective view of a light fixture according to another embodiment of the invention.

FIG. 4 is a cross-sectional view of the light fixture of FIG. 3 taken along line 4-4.

FIGS. 5 and 6 are cross-sectional views of alternative embodiments of a light fixture.

FIGS. 7-9 are detailed views of optics comprising prismatic elements according to certain embodiments of the invention.

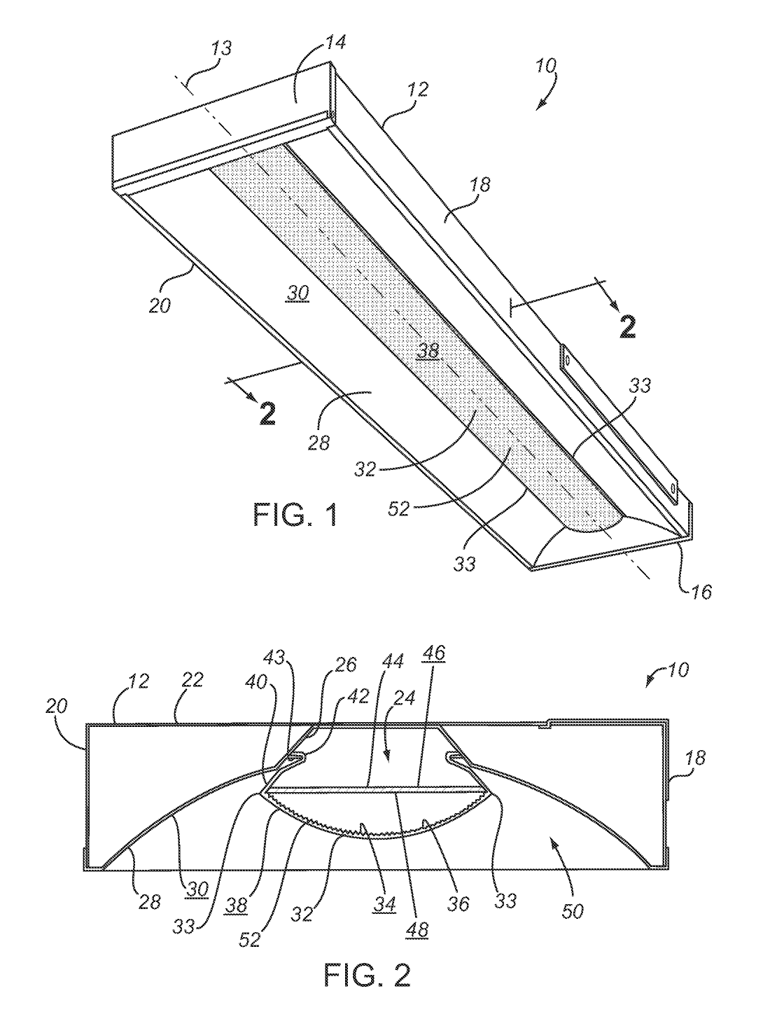

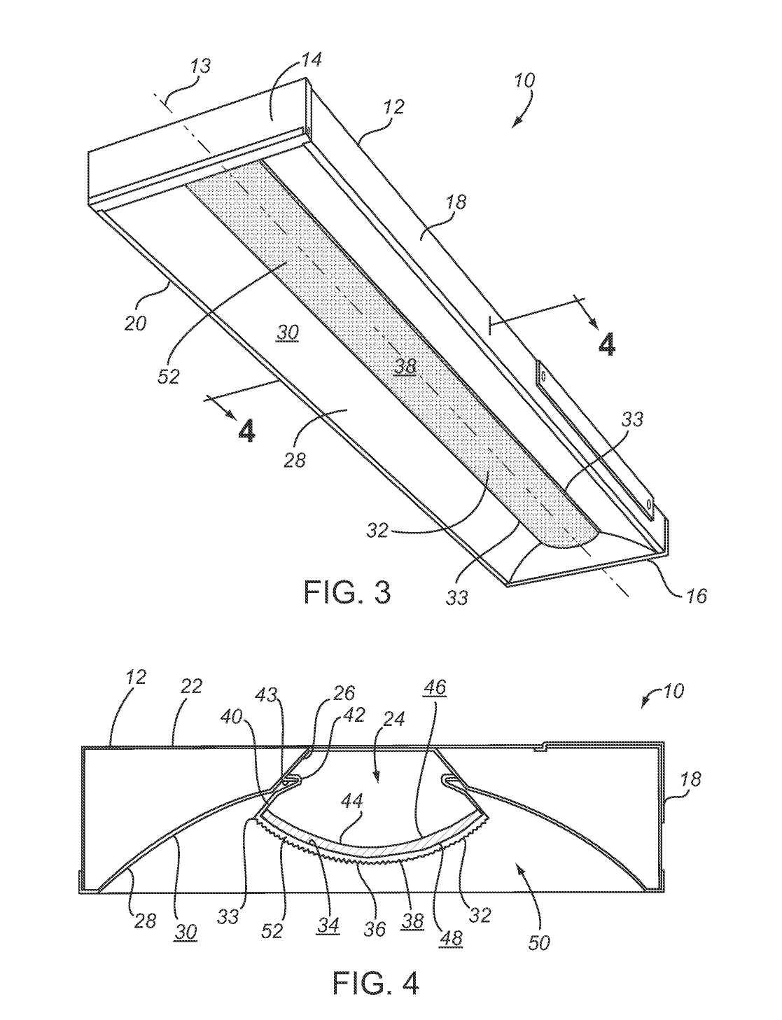

### DETAILED DESCRIPTION OF THE INVENTION

Certain embodiments of the invention provide a light fixture 10 comprising an organic light emitting diode (OLED) 44 as the light source, and further comprising a housing 12, at least one hollow 28, and an optic 32.

In certain embodiments of the invention, traditional fluorescent light fixtures commonly known as “RT5” light fixtures may be retro-fitted with an OLED 44. Embodiments of such a light fixture are shown and described in U.S. Pat. No. 7,229,192, which is incorporated herein by reference. Retro-fitting an existing RT5 light fixture may be desirable to reduce manufacturing costs and to retain RT5 fixtures that are already in use. In other embodiments, however, the OLED 44 may be fitted into other types of light fixtures 10, and not necessarily an RT5 light fixture. It should be understood that the light fixtures 10 shown in the figures may represent either a traditional RT5 fixture or any other type of light fixture 10.

In certain embodiments the housing 12 of the light fixture 10 comprises a first end wall 14, a second end wall 16, a first side wall 18, and a second side wall 20. As shown in FIG. 2 (and the other cross-sectional figures), the housing 12 may also include a mounting panel 22. If it is desired to mount the light fixture 10 to a surface (such as a ceiling or a wall), the mounting panel 22 may contact the surface. There may optionally be provided mounting hardware (not shown) to mount the light fixture 10 to the surface. In the embodiments shown in the figures, the housing 12 is generally rectangular. In other embodiments, however, the housing 12 may comprise other shapes. For example, any one of the walls 14, 16, 18, or 20 may be curved and/or angled. There may also be provided fewer or more than four walls 14, 16, 18, or 20.

The light fixture 10 may also include at least one hollow 28. As shown in the figures, the hollow 28 extends generally parallel with the longitudinal axis 13 of the light fixture 10. The hollow 28 may be curved if desired. In the figures, the hollow 28 is concave such that the two hollows 28 form the shape of a partial arch. But in other embodiments the hollow 28 may have no curve at all or may be convex. As explained in more detail herein, at least a portion of the hollow 28 may include a reflective surface 30 that reflects light into the intended area 50. The intended area 50 is the area into which light is reflected by the reflective surface 30 and/or the area into which light emanates from the OLED 44.

The light fixture 10 may also include a trough 24 that is defined by two trough walls 26. In traditional RT5 fixtures, the trough 24 houses the fluorescent lamp such that the fluorescent lamp contacts the mounting panel 22. Such contact between the mounting panel 22 and a traditional fluorescent lamp may be needed to increase heat-transfer. But embodiments of the present invention use an OLED 44 rather than a fluorescent lamp. OLEDs 44 emit heat over a wider surface area than traditional fluorescent lamps, and thus, heat transfer with the mounting panel 22 may not be necessary for OLEDs 44. Thus, the trough 24 may be used to house any other components or electronics that are desired for the light fixture 10. Embodiments of light fixtures that do not use the traditional RT5 housing may not include trough 24.

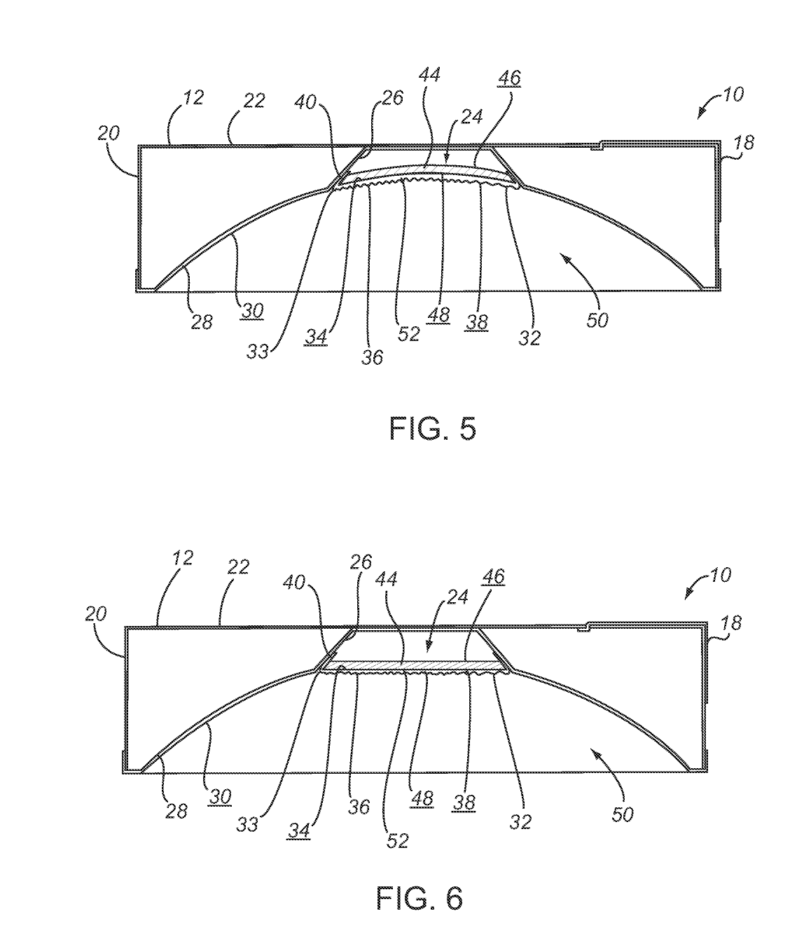

Additionally, the light fixture 10 may include an optic 32 that refracts the light emitted by the OLED 44. The optic 32 has a refractive portion 52 defined by two edges 33. When coupled to the light fixture 10, the refractive portion 52 is visible to observers. In FIG. 2 the refractive portion 52 is convex, in FIG. 5 the refractive portion 52 is concave, and in FIG. 6 the refractive portion 52 is generally straight. Thus, the shape of the refractive portion 52 is not limiting. The refractive portion 52 has an inner surface 34 that faces the OLED 44 and an outer surface 38 that faces the intended area 50 of light. As described in more detail below, at least one of the inner or outer surfaces 34, 38 may include prismatic elements 36 that refract the light.

Arms 40 may extend from the edges 33 of the optic 32 to detachably secure the optic 32 to the light fixture 10. For example, the arms 40 of optic 32 may flex together and fit within the trough walls 26. In the embodiments shown in FIGS. 5 and 6, there may be a friction fit between the trough walls 26 and the arms 40. Additionally, the arms 40 and/or the trough walls 26 may include structure to secure the optic 32 to the light fixture 10. In FIGS. 2 and 4, the trough walls 26 have at least one protrusion 43 and the arms 40 have an end portion 42 that is sized and shaped for detachable engagement with the protrusion 43. In other embodiments (not shown), the trough walls 26 may include an aperture and the end portion 42 of the arms 40 may be inserted into the aperture. One of skill in the art would understand that many types of structure may be provided on the trough walls 26 and/or the arms 40 to detachably secure optic 32 to the light fixture 10. In certain embodiments, the optic 32 may be made of polycarbonate or acrylic and may be optical grade if desired. The optic 32 can be of a clear material, a translucent material, and may be colored or tinted.

The light fixture 10 additionally includes an OLED 44 which emits light and thus acts as the light source for the light fixture 10. In general, the OLED 44 has a first surface 46 and a second surface 48 opposite the first surface 46. Light is emitted out of the second surface 48 and into the intended area 50. OLEDs 44 for use in embodiments of the invention may be any color (including white), or a combination of colors. The OLED 44 may be any shape. In one embodiment, the OLED 44 has approximately the same shape and dimensions as the refractive portion 52. For example, the second surface 48 of the OLED 44 may have approximately the same shape (e.g. curvature) as the inner surface 34 of the optic 32 to facilitate mating the two together. However, in other embodiments, the OLED 44 may have a different shape than the refractive portion 52.

One or more OLEDs 44 may be provided in the fixture 10. For example, if the length of the OLED 44 was smaller than that of the optic 32, then there may be several OLEDs 44 along the length of the optic 32. Manufacturers such as the Eastman Kodak Company, Royal Philips Electronics, or Panasonic Electric Works make suitable OLEDs 44 for use in embodiments of the invention.

While the OLED 44 may be positioned within the trough 24, optical efficiencies may be realized by positioning the OLED 44 in close proximity to or within the intended area 50 of the light fixture 10. In the embodiments shown in FIGS. 2 and 4, the OLED 44 is positioned within the intended area 50 of the light fixture 10; in the embodiments of FIGS. 5 and 6, the OLED 44 is coincident with the intended area 50. In this way, light emission within the trough 24 is minimized and the optical paths to the refractive portion 52 and the reflector surface(s) 30 are shortened.

In the embodiment of FIG. 2, the OLED 44 is secured to the edges 33 of the optic 32. Such attachment positions the OLED 44 closer to the refractive portion 52 and within the intended area 50, thus increasing optical efficiency. The OLED 44 may be secured to the edges 33 by any means known in the art, including but not limited to adhesive, welding, or mechanical fasteners. In FIG. 2, the inner surface 34 of the refractive portion 52 comprises prismatic elements 36 while the outer surface 38 is substantially smooth. In other embodiments, however, the inner surface 34 is smooth while the outer surface 38 comprises prismatic elements 36. The prismatic elements 36 refract the light emitted from the OLED 44 as described in more detail below.

In the embodiments shown in FIGS. 4-6, the OLED 44 may be directly secured to the refractive portion 52 such that there is no space between the OLED 44 and the refractive portion 52. Thus, the second surface 48 of the OLED 44 contacts the inner surface 34 of the refractive portion 52 such that substantially all of the second surface 48 of the OLED 44 contacts (directly or indirectly) the inner surface 34 of the optic 32. If the refractive portion 52 is curved (such as in FIGS. 4 and 5), then the OLED 44 may be printed onto a flexible substrate so that it may flex to match the shape of the refractive portion 52. The OLED 44 may be secured to the refractive portion 52 by any means known in the art, including but not limited to adhesive, welding, or mechanical fasteners. If adhesive is used, it may be desirable to select an adhesive that is optically matched to the OLED 44 and/or the refractive portion 52. In the embodiments shown in FIGS. 4-6, the inner surface 34 of the refractive portion 52 is smooth in order to reduce “intervening refraction” caused by any air pockets or gaps that may be formed between the OLED 44 and the refractive portion 52. Direct optical coupling may thus be achieved by at least one of: causing the second surface 48 of the OLED 44 to directly or indirectly contact the inner surface 34 of the refractive portion 52, providing an inner surface 34 that is smooth, and/or selecting an optically-matched adhesive. The direct optical coupling increases optical efficiency. If desired, direct optical coupling may be used to seal one side of the OLED 44. The outer surface 38 of the refractive portion 52 may comprise prismatic elements 36 to refract the light as described below.

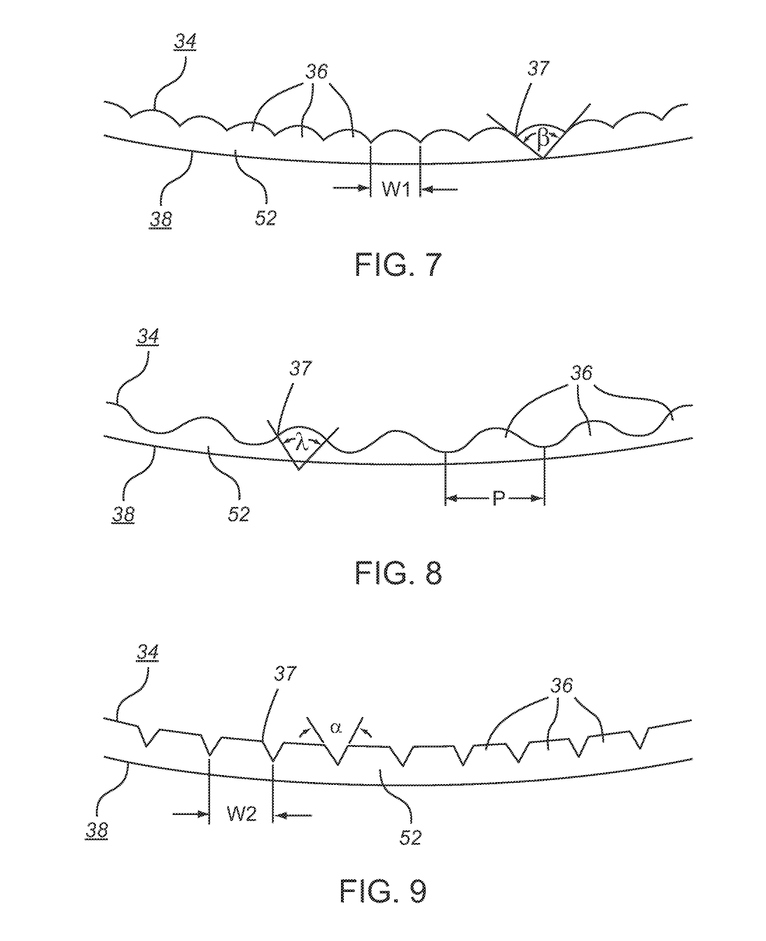

In any of the embodiments described herein, the refractive portion 52 may optionally include a plurality of prismatic elements 36 to refract light. Some non-limiting embodiments of prismatic elements 36 are illustrated in FIGS. 7-9. In FIG. 7, the prismatic elements 36 have an arch shape with an angle of incidence β and width W1. In FIG. 8, the prismatic elements 36 are sinusoidal shaped with an angle of incidence λ and having a period P. In FIG. 9, the prismatic elements 36 have generally flat tops with an angle of incidence α and a width W2. In any embodiment, adjoining prismatic elements 36 are integrally connected at a common cusp 37. Different refractive properties may be achieved by varying the shapes of prismatic elements 36, the angles of incidence (β, λ, or α) and/or the period P or widths W1, W2. For example, because an OLED 44 may tend to have a surface area from which the light emanates that is larger than that of other light sources (such as a fluorescent lamps), it may be desirable to provide a relatively smaller period P and/or widths W1, W2, or alternatively, to provide a smaller angle of incidence (β, λ, or α). But the geometry of the prismatic elements 36 is by no way limiting. The prismatic elements 36 create a striped visual characteristic to an external observer, which provide for visual interest in the optic 32. The prismatic elements 36 additionally help control high-angle glare. U.S. Pat. No. 7,229,192 fully explains how the prismatic elements 36 refract the light and is incorporated herein by reference in its entirety.

Use of an OLED 44 as the light source is preferable because the OLED 44 has more surface area than known fluorescent lamps having small diameters. Additionally, the OLED 44 may be placed close to the refractive portion 52—either directly contacting the refractive portion 52 as in FIGS. 4-6 or with a small space as in FIG. 2—which creates the appearance as if the refractive portion 52 itself is the light source. This proximity of the OLED 44 to the refractive portion 52 is improved from known light fixtures with fluorescent lamps, where the fluorescent lamp was separated from the refractive portion 52. Yet another improvement is the proximity of the OLED 44 to the intended area 50. In FIGS. 2 and 4, the OLED 44 is positioned within the intended area 50, and in FIGS. 5 and 6 the OLED 44 is coincident with the intended area 50. This close proximity of the OLED 44 to the reflective surface 30 allows a maximum amount of light to be reflected into the intended area 50. Additionally, if desired the hollows 28 may be curved such that the reflective surface 30 reflects the light in a spherical distribution, creating volumetric lighting.

One of skill in the art would understand how to modify an existing RT5 light fixture to create the light fixture 10 described herein. For example, the fluorescent lamp may be removed from the trough 24. An OLED 44 could be coupled to the optic 32, either along the edges 33 of the optic 32 (as in FIG. 2), or by coupling the second surface 48 of the OLED 44 to the inner surface 34 of the refractive portion 52 (as in FIGS. 4-6). Any desired power source or wiring (not shown) could be stored in the trough 24. Manufacturing expenses and waste are reduced by modifying existing RT5 light fixtures.

The foregoing is provided for purposes of illustration and disclosure of embodiments of the invention. It will be appreciated that those skilled in the art, upon attaining an understanding of the foregoing may readily produce alterations to, variations of, and equivalents to such embodiments. Accordingly, it should be understood that the present disclosure has been presented for purposes of example rather than limitation, and does not preclude inclusion of such modifications, variations and/or additions to the present subject matter as would be readily apparent to one of ordinary skill in the art.

1. A light fixture comprising:
a housing comprising a first side wall, a second side wall, and a mounting panel, wherein the mounting panel may be secured to a wall or a ceiling;
a trough within the housing and adjacent to the mounting panel, wherein the trough is defined by a first trough wall and a second trough wall;
a first hollow extending between the first trough wall and the first side wall;
a second hollow extending between the second trough wall and the second side wall;
an optic to refract light and comprising an inner surface and an outer surface opposite the inner surface; and
an OLED comprising a first surface and a second surface opposite the first surface, wherein the second surface emits light, and wherein the OLED is coupled to the optic such that substantially all of the second surface of the OLED contacts the inner surface of the optic.

2. The light fixture as in claim 1, wherein the optic comprises at least one of polycarbonate or acrylic.

3. The light fixture as in claim 1, wherein the OLED is coupled to the optic by adhesive, and wherein the adhesive is optically matched to at least one of the OLED or the optic.

4. The light fixture as in claim 1, wherein the inner surface of the optic is curved, and wherein the OLED comprises a flexible substrate to thereby contact the curved inner surface of the optic.

5. The light fixture as in claim 1, wherein at least a portion of the first hollow and the second hollow comprises a reflective surface that reflects light emitted by the OLED.

6. The light fixture as in claim 1, wherein the outer surface of the optic comprises at least one prismatic element.

7. The light fixture as in claim 1, wherein the inner surface of the optic is substantially smooth.

8. A light fixture comprising:
a housing comprising a first side wall, a second side wall, and a mounting panel, wherein the mounting panel may be secured to a wall or a ceiling;
a trough within the housing and adjacent to the mounting panel, wherein the trough is defined by a first trough wall and a second trough wall;
a first hollow extending between the first trough wall and the first side wall;
a second hollow extending between the second trough wall and the second side wall, wherein at least a portion of the first hollow and the second hollow comprises a reflective surface and thereby define an intended area of the light fixture;
an optic coupled to the trough and comprising a refractive portion, wherein the refractive portion protrudes into the intended area of the light fixture; and
an OLED comprising a first surface and a second surface opposite the first surface, wherein the second surface emits light and wherein the OLED is coupled to the optic such that the second surface is inside of the intended area of the light fixture.

9. A light fixture as in claim 8, wherein the refractive portion comprises an inner surface and an outer surface and wherein at least one of the inner or outer surface comprises at least one prismatic element to refract the light.

10. A light fixture as in claim 8, wherein the light emitted by the OLED is refracted by the optic and reflected by the reflected surface into the intended area of the light fixture.

11. A light fixture as in claim 8, wherein the refractive portion of the optic is defined by two edges and wherein the OLED is coupled to the two edges of the optic.

12. A light fixture as in claim 8, wherein the OLED is defined by at least two edges, and the at least two edges of the OLED are coupled to the at least two edges of the optic.

13. A light fixture as in claim 8, wherein the refractive portion is at least one of curved or straight.

14. A light fixture as in claim 8, wherein the first hollow and the second hollow are curved.

15. A method of modifying a light fixture comprising:
a housing comprising a first side wall, a second side wall, and a mounting panel, wherein the mounting panel may be secured to a wall or a ceiling;
a trough within the housing and adjacent to the mounting panel, wherein the trough is defined by a first trough wall and a second trough wall;
a first hollow extending between the first trough wall and the first side wall;
a second hollow extending between the second trough wall and the second side wall, wherein at least a portion of the first hollow and the second hollow comprises a reflective surface;
a fluorescent lamp secured within the trough; and
an optic defined by two edges and comprising an inner surface and an outer surface opposite the inner surface, wherein the optic is detachably secured to the trough and covers at least a portion of the fluorescent lamp, wherein the method of modifying the RT5 light fixture comprises:
removing the existing fluorescent lamp; and
coupling at least one OLED to the optic, wherein the OLED comprises a first surface and a second surface opposite the first surface, and wherein the OLED is coupled to the optic by at least one of coupling the OLED to the two edges of the optic, or by coupling the second surface of the OLED to the inner surface of the optic such that substantially all of the second surface of the OLED contacts the inner surface of the optic.

16. The method as in claim 15, further comprising positioning a power source within the trough.

17. The method as in claim 15, further comprising coupling an additional OLED to the optic.
